(19) United States
(12) Patent Application Publication
(10) Pub. No.: US 2007/0174109 A1
(43) Pub. Date: Jul. 26, 2007

(54) SYSTEM AND METHOD FOR TRANSFORMING AN ENTERPRISE USING A COMPONENT BUSINESS MODEL

(76) Inventors: David L. Cohn, Dobbs Ferry, NY (US); Robert Delamarter Dill, Raleigh, NC (US); George M. Galambos, Montreal (CA); Robert H. Guttman, Stamford, CT (US); Raman Harishankar, Blacklick, OH (US); David Robert Kress, Carmel, IN (US); Clifford Alan Pickover, Yorktown Heights, NY (US); Guy Jonathan James Rackham, New York, NY (US); John R. Smith, New York, NY (US); Stephen Michael Smith, Westlake Village, CA (US); John George Vergo, Yorktown Heights, NY (US)

Correspondence Address: Whitham, Curtis, Christofferson & Cook, P.C., Suite 340, 11491 Sunset Hills Road, Reston, VA, 20190, US

(21) Appl. No.: 11/684,002

(22) Filed: Mar. 8, 2007

Related U.S. Application Data
(63) Continuation-in-part of application No. 11/176,371, filed on Jul. 8, 2005.
Application No. 11/176,371 is a continuation-in-part of application No. 10/796,367, filed on Mar. 9, 2004.

(51) Int. Cl. G06Q 99/00; G07G 1/00; G06F 17/30

(52) U.S. Cl. 705/10; 705/1

(57) ABSTRACT

A system and method are described for using a Component Business Model (CBM) to transform a business. A CBM map is used to identify components that collaborate to provide a specified capability, and a repository supporting the CBM map is filtered to provide a view of the identified components that highlights how they collaborate. The view is used to identify component features contributing to the specified capability. The specified capability is then enhanced by a transformation strategy that includes re-engineering particular components, identifying a pattern characterizing the collaboration between components and adding a component to perform the collaborative pattern, and/or adding an additional feature to the collaboration and adding component to perform the additional feature. The CBM repository provides exemplar best practices that can be adapted for use in a re-engineered component.

This invention is a continuation in part from commonly owned and co-pending patent application Ser. No. 11/176,371 for “SYSTEM AND METHOD FOR ALIGNMENT OF AN ENTERPRISE TO A COMPONENT BUSINESS MODEL”, which is a continuation in part of co-pending application Ser. No. 10/796,367 entitled “SERVICES COMPONENT BUSINESS OPERATION METHOD”, which applications are incorporated by reference herein.

### BACKGROUND OF THE INVENTION

1. Field of the Invention

The present invention generally relates to component based business models and, more particularly, to techniques for transforming an enterprise using a Component Business Model.

2. Background Description

Existing approaches to business transformation are restricted by the limited perspectives supported by each approach. Traditional approaches focus on process by process analysis and corresponding improvements, and may not consider aspects of the business that are related to a process, such as the people involved in the process, how the people are organized, and technology and operational considerations, but whose significance for the business as a whole are not evident from the perspective supported by traditional approaches. Furthermore, traditional approaches are not good at tracing dependencies and repercussions of change.

Traditional approaches seek to represent aspects of business operation as processes that can be streamlined and optimized through the exploitation of technology, most commonly technology deployed to automate a well defined business behavior. This view limits its focus to aspects of business behavior related to a particular process, and also tends to focus on how technology can be deployed to mechanize activity within that process. These approaches leverage a combination of at least six different concepts: 1-eliminate redundant steps, 2-automate manual steps, 3-do more things in parallel, 4-identify shared capabilities, 5-seek low cost sourcing approaches, and 6-eliminate variations in processing. These approaches are applied to established end to end processes, but do not deal with the cross process perspective.

What is needed is an alternative view that seeks to identify distinct and specialized aspects or ingredients of business that participate in different combinations and sequences in the execution of business activity, across any and all processes that rely upon any one of these operationally distinct capabilities.

### SUMMARY OF THE INVENTION

It is therefore an object of the invention to incorporate cross process implications into component improvement tasks.

Another object of the invention is to use a Component Business Model to look at the upstream and downstream implications of change for selected processes and combinations of processes that might reference particular business components.

It is also an object of the invention to use a Component Business Model to identify radical transformations by changing the role of individual components (e.g. evolving from a processor role to a gatekeeper role, and by changing the role thereby exposing opportunities to transform the realization of the processes in which the component participates).

A further object of the invention is to use a Component Business Model to identify transformations that better handle key business assets by integration of consolidator/server components (e.g. through an analysis of the collective references to a key item of business information or business intelligence).

Yet another object of the invention is to use a Component Business Model to identify transformations that better handle key business events, for example, through the integration of gatekeeper components that support complex orchestration of parallel asynchronous execution paths.

It is another object of the invention to use the CBM repository to share effective component designs and collaborative patterns within and across industries.

A further object of the invention is to isolate the unique and non overlapping ingredients of the business for all relevant processes and examine the patterns of their collaboration for multiple process scenarios, thereby exposing new insights into business behavior that can drive operational design and carry through to the underlying technology and organizational support needs.

It is therefore also an object of the invention to use the foregoing specific business component operational roles and patterns to transform business behavior.

An aspect of the invention is a method for transforming a business by using a Component Business Model (CBM) to generate a display linking a specified capability to component features contributing to the capability, and enhancing performance of the specified capability by transforming the contributing components. In another aspect, using a Component Business Model further comprises using a CBM map to identify collaborating components for the specified capability, the CBM map being a display generated from a CBM repository; filtering a view of the identified components from the CBM repository, the view including linkages between services relied upon and services provided by the identified components; and identifying from said filtered view features of each component contributing to the specified capability.

In a further aspect of the invention, enhancing performance of the specified capability further comprises searching the CBM repository for exemplar applications of the contributing features, and adapting the exemplar applications for use by the respective identified components having the respective contributing features. Alternatively, enhancing performance of the specified capability further comprises identifying a collaborative pattern for the collaborating components, and adding a component to perform the identified collaborative pattern.

Another aspect of the invention comprises identifying additional features for the specified capability, and adding to the view at least one component providing the added features. In another aspect, the collaborative pattern is a predefined process and the added component is a gatekeeper component. In yet another aspect the collaborative pattern is independent interconnection and the added component is a consolidator/server component. In a further aspect of the invention a single component is identified and the contributing features are features of the single component. It is also an aspect of the invention to outsource at least one of the identified and adapted components. In another aspect of the invention at least one of the identified components is provided by an entity external to the business. A further aspect of the invention comprises integrating the external component into the business.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic diagram of the method of the invention.

FIGS. 2A through 2C show an exemplar application of the invention to collaborating business components transformed to generate a “just in time distribution” capability. FIG. 2A is a schematic showing extraction of collaborating components from a CBM map. FIG. 2B is a schematic showing the aspects of each collaborating component of particular use for a “just in time distribution” capability. FIG. 2C is a schematic showing the addition of components to refine the “just in time distribution” concept.

FIGS. 3A and 3B show exemplar applications of the invention to particular collaborative groupings of components.

FIGS. 4A through 4E are diagrams illustrating transitions to improved component collaboration configurations: consolidator components (4A); gatekeeper components (4B); processor components (4C); controller components (4D); and analyzer components (4E).

### DETAILED DESCRIPTION OF A PREFERRED EMBODIMENT OF THE INVENTION

A component view of an enterprise allows one to look at the full range of processes in place, and even map those which might evolve. This more complete ‘network’ view of business activity (where a process is one instance of traversing the network) allows two additional perspectives to be exposed and applied in seeking out and specifying transformation. One additional perspective is obtained by revealing nodes on the network where critical business information or resources touched by multiple processes can be exploited in a coordinated manner. For example, this kind of analysis can reveal potentially competing allocation of staff or capital to efforts; or this kind of analysis can provide a consolidated view of value to a business.

Another perspective provided by this kind of analysis is showing interrelationships between processes, where a business situation or event occurring in the flow of one process can be the trigger for spawning multiple additional processing in a manner potentially unrelated and asynchronous to the triggering processes. For example a customer may call in to check their balance, and this can trigger new processes that take the opportunity presented by the call to sell new services and deliver pending mail.

The business component view employed by the invention, in contrast to traditional approaches that represent the business as processes that can be streamlined, seeks to identify distinct and specialized aspects or ingredients of business that participate in different combinations and sequences in the execution of business activity for any and all relevant processes. By isolating these unique and non overlapping ingredients and examining the patterns of their collaboration for multiple process scenarios the invention exposes new insights into business behavior that can drive operational design and carry through to the underlying technology and organizational support needs.

The invention uses the Component Business Model (CBM) described in co-pending parent patent application Ser. No. 11/176,371 for “SYSTEM AND METHOD FOR ALIGNMENT OF AN ENTERPRISE TO A COMPONENT BUSINESS MODEL” (hereafter termed “the above referenced foundation patent application”). CBM provides a logical and comprehensive view of the enterprise, in terms that cut across commercial enterprises in general and industries in particular. The Component Business Model as described in the above referenced foundation patent application is based upon a logical partitioning of business activities into non-overlapping managing concepts, each managing concept being active at the three levels of management accountability: providing direction to the business, controlling how the business operates, and executing the operations of the business.

The term “managing concept” is specially defined as described in the above referenced foundation patent application, and is not literally a “managing concept” as that phrase would be understood in the art. For the purpose of the present invention, as for the related invention, “managing concept” is the term associated with the following aspects of the partitioning methodology. First, the methodology is a partitioning methodology. The idea is to begin with a whole and partition the whole into necessarily non-overlapping parts. Second, experience has shown that the partitioning process works best when addressed to an asset of the business. The asset can be further described by attributes, and the role of the asset can be used to identify how the asset can be leveraged commercially. This identification is termed an “asset type”. This terminology allows definition of a finite list of generic elements associated with an “asset” that a business might want to exploit. For example, an individual staff person might be realized as three asset types: a resource that can perform tasks; a resource that may have expertise; and a resource that may have business intelligence.

Third, the managing concept must include mechanisms for doing something commercially useful with the asset. For a sensibly defined managing concept these mechanisms must cover the full range of management accountability levels (i.e. direct, control and execute). Managing concepts are further partitioned into components, which are cohesive groups of activities. In combination, all the components within a managing concept support some structured mechanism for the exploitation of the asset type.

The boundaries of a component usually fall within a single management accountability level. It is important to emphasize that the boundaries between managing concepts (and between components within managing concepts) are logical rather than physical.

The Component Business Model (CBM) described in the above referenced foundation patent application presents a number of design considerations that enable the present invention. These may be summarized by reference to FIGS. 9A and 9B in the above referenced foundation patent application, which describe (in FIG. 9B) the simplification provided by the CBM view of a business. Whereas in the prior art process view business change results in increasingly complex and inefficient aggregations of processes, the CBM view presents a relatively simplified lens (i.e. fewer components than processes) through which these process development inefficiencies may be addressed. Further, this capability provided by the CBM view may be understood in two senses. First, the view may be applied as a corrective for accumulated inefficiencies. Second, when the view is applied going forward, transformation of the business can proceed so as to minimize further accumulation of inefficiencies.

The present application further develops the business transformation methodology outlined in the above reference foundation patent application. Of course, as noted in the above reference foundation patent application, the partitioning methodology for developing a CBM view of a business is difficult to accomplish in practice and therefore requires an iterative approach. At any one point in time the CBM view of a business may be described as a work in progress. Consequently, in practical application, the CBM based methodology for transformation of a business is dependent upon the extent to which a CBM view has been or is being developed for the business. Typically, development of a CBM view for a particular business is undertaken precisely for the purpose of achieving a transformation whose parameters are not well understood at the outset precisely because there is not yet a CBM view upon which can be overlaid the relevant business activities of interest.

For the purposes of this application, however, it will be assumed that a CBM view of the business is in place, that is, the business has been parsed into non-overlapping managing concepts and further parsed into non-overlapping components, as described in the above referenced foundation patent application. These components represent unique specialist operational capabilities that collectively constitute the overall business operation. The arrangement of non-overlapping components serves as an organizing framework for underlying combinations of systems, staffing organization, and procedures (see FIGS. 6A, 6B and 6C of the above referenced foundation patent application).

Any current or desired business process can be realized by combinations of collaborating components. Typically, collaboration is accomplished through service interactions. A component may participate in an unrestricted number of possible processes, but its participation will always relate to its particular specialization, although different aspects of a component's detailed functionality and service make-up may be involved in different processes.

A business component view creates a unique representation of a process as a combination of specialist service centered interactions as defined in the above referenced foundation patent application, with the ability to overlay multiple process views on the collection of components. This allows modeling of the business operational contribution of any component with respect to its overall participation in any and all identified processes that invoke it. Furthermore, this collective view of a component's support of multiple processes allows the present invention to design transformations by evolving the role of a component.

For example, the legacy of a process orientation may be a component having a traditional processor role, where it supports a consistently defined step in a process design. The CBM view makes visible situations where a component—which is defined by logical rather than physical partition boundaries—plays a processor role in a plurality of business processes. This visibility enables exploitation of cross process synergies in terms of triggering or coordinating parallel business activity and sharing business informational insights. These latter collective or network views are the unique operational design insights that are the basis for identifying transformations enabled by CBM.

The value of this synergy enabling view may be readily appreciated. An operational behavior viewed as an isolated part of process A (and also present as an isolated part of process B, and similarly for a third process C) can be transformed into a decoupled capability serving processes A, B and C, and more readily leveraged to serve a new process D. Further, the leveraging potential may warrant extension of the component's role to serve as a gatekeeper for invocations of component services triggered by events elsewhere in the business. Another variant on this synergy from the CBM view would follow from the observation that service interactions among a group of components—made visible by an overlay upon a CBM map—could be simplified by creating a specialized component to serve as a common hub for these interactions.

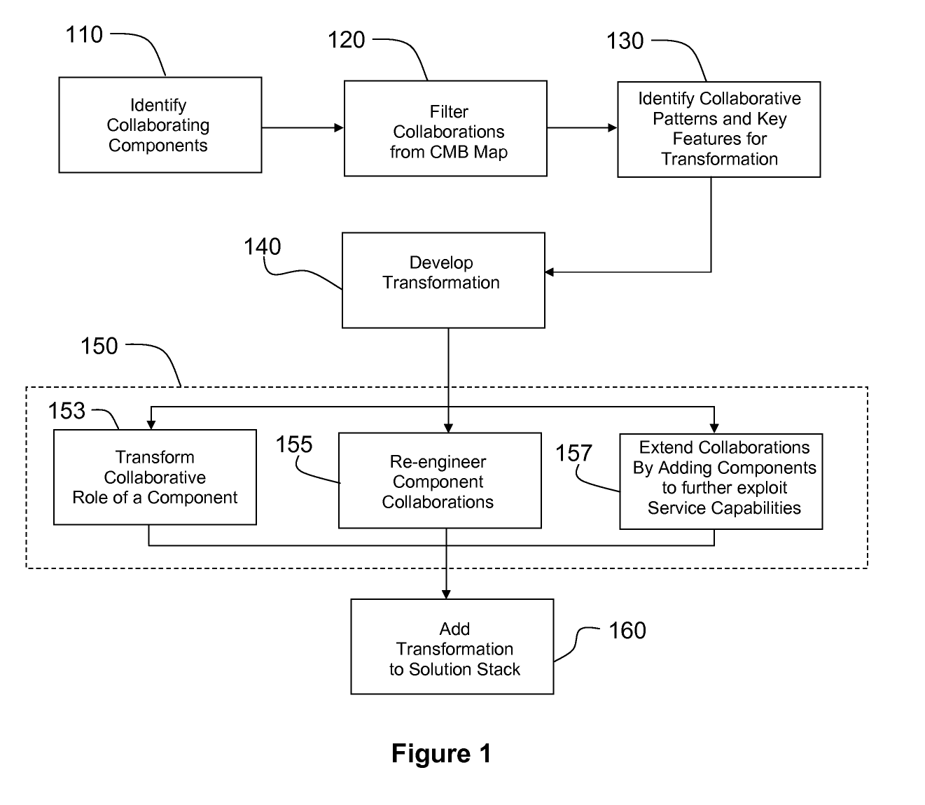

The invention will now be explained with reference to FIG. 1, which shows identification of collaborating components 110 selected for application of the invention. These are identified using the Component Business Model (CBM) view, for example by considering process overlays upon a CBM map. The collaborative patterns relating these components are obtained as a view 120 from the CBM repository, based on identification of the components on the CBM map. Features in each component that will be central to the transformation are then identified 130 using the information in the repository made accessible by the view 120. The transformation may then be developed 140 by application of one or more transformation techniques 150 drawing upon the visibility provided by the CBM view. These techniques may include re-engineering 153 of a component so as to transform its collaborative role, where the resources and operation of the component are redesigned to better use the services available to the component and improve the quality and responsiveness of the services provided by the component. For example, the component may be re-engineered to assume a gatekeeper role, being decoupled from particular business processes so as to handle the triggering of multiple and asynchronous invocations of the component's services.

Another technique is transformation 155 of the collaborative pattern existing among the identified components. For example, a pattern of independent collaboration among the components could be transformed by development of a consolidator/server functionality, either by evolution of an existing component or creation of a specialized component for that purpose. A further technique for transforming an identified group of collaborating components is to add components 157, thereby refining or developing service capabilities not adequately exploited by existing relationships among the collaborating components. The design of the transformation is then completed and added 160 to the solution stack.

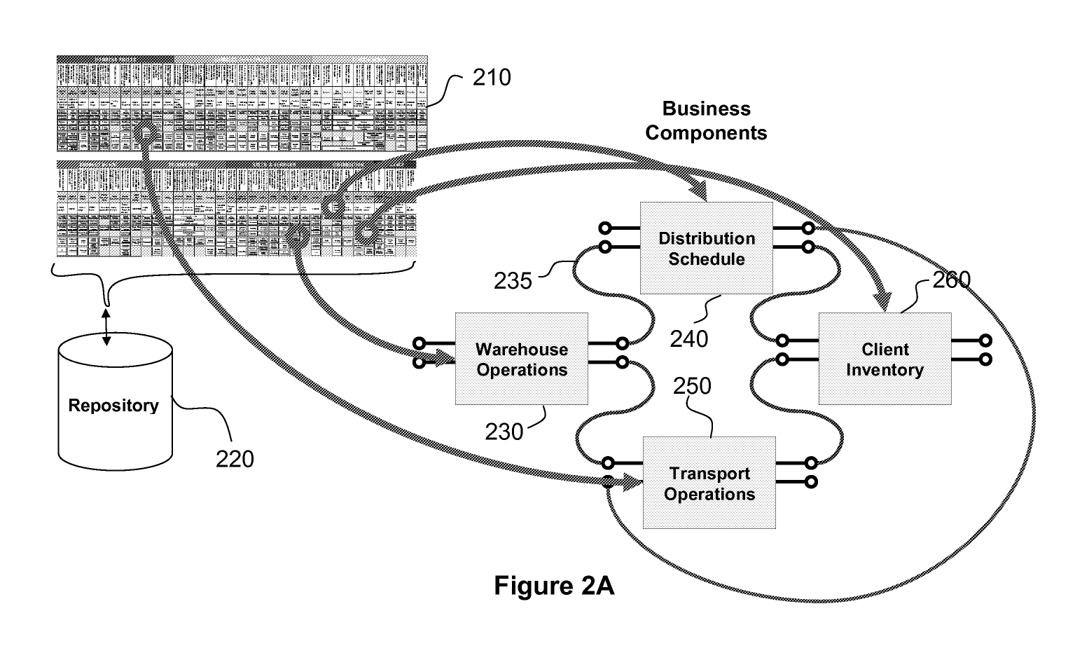

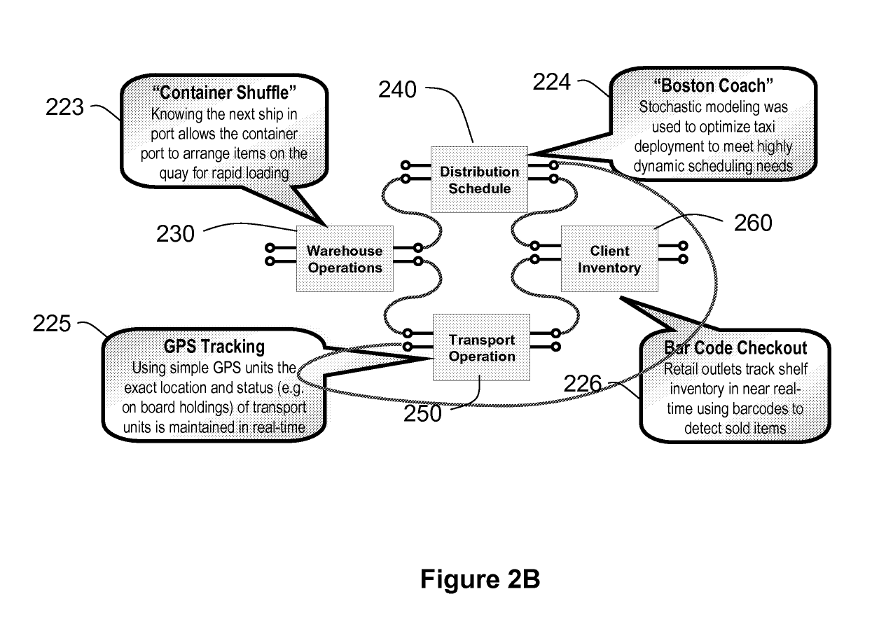

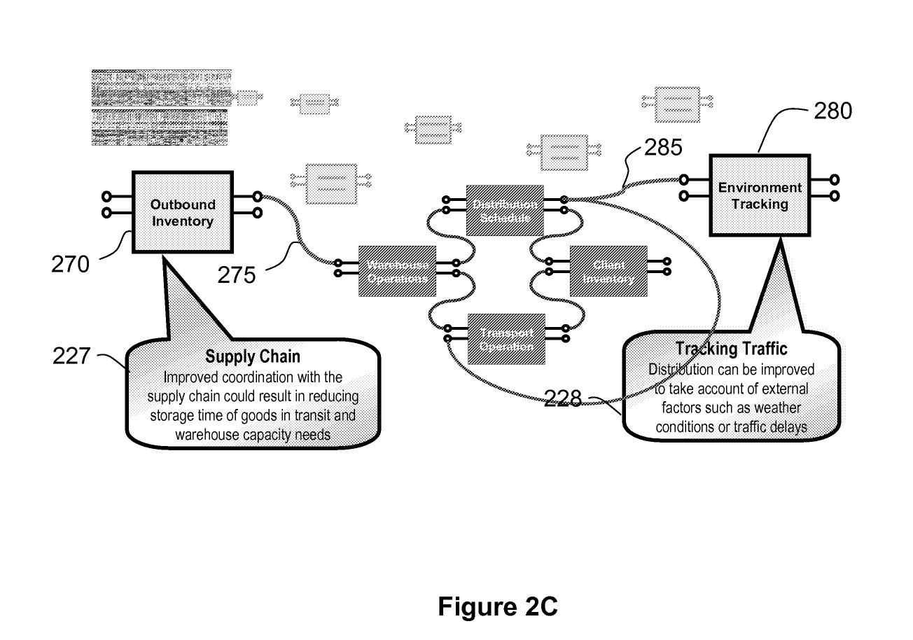

The foregoing method may be illustrated with reference to FIGS. 2A through 2C. Suppose a business enterprise decides to develop a capability to distribute supplies needed by customers so that the supplies arrive as they are needed, minimizing the time that the supplies are waiting in inventory. The component map 210 is a high level view of the CBM repository 220, and is used to identify business components for a “just in time distribution” capability. Once identified, the invention provides for extraction from the component map 210 of the selected components, with the extracted view showing the linkages (i.e. collaborations) between the services relied upon and the services provided by each component. For example, link 235 shows that services provided by warehouse operations 230 are relied upon by the distribution schedule component 240. Note that, by convention, inputs to a component are on the left and outputs are on the right.

In this example, there are four components selected: warehouse operations 230, distribution scheduling 240, transport operation 250, and client inventory 260. For each of these components an aspect is identified that will contribute to the performance of the “just in time distribution” capability desired for the transformation. These may be drawn from “best practices” aspects stored in the CBM repository 220, as shown in FIG. 2B. These best practices are made visible to a component by the relationship between the CBM map and the CBM repository 220. For example, the warehouse operations component 230 can be enhanced by using the “container shuffle” best practice 223 stored in the repository 220. This practice relates to the shipping vehicles used to transport supplies to and from the warehouse. In the best practice example, knowing the next ship that is coming into a port allows the container port to arrange items on the quay for rapid loading. Generalizing this best practice for application to warehouse operations 230 allows optimum use of warehouse loading dock space to expedite the loading and unloading of delivery trucks and other vehicles arriving at particular facilities managed by the warehouse operations component 230.

Similar analysis is provided for the other components participating in the “just in time distribution” collaborative pattern. Stochastic modeling is added to the distribution scheduling component 230, based on the “Boston Coach” best practice 224 taken from repository 220. In the “Boston Coach” example, stochastic modeling was used to optimize taxi deployment to meet highly dynamic scheduling needs. This example is adapted to optimize use of the delivery vehicles available to distribution scheduling component 230. GPS tracking technology 225 is also identified in the repository 220 as able to provide in real time the exact location and status of transport units monitored by the transport operation component 250. By adding simple GPS units to the delivery vehicles, the monitoring function of the transport operation component 250 will be enhanced. The operations of the client inventory component 260 will be enhanced by application of bar code technology, based on an adaptation of an example 226 stored in repository 220, where retail outlets were able to use a bar code scan at checkout to track shelf inventory in near real time.

The transformation may be further refined by adding components having aspects important for operation of the “just in time distribution” capability, as shown in FIG. 2C with the addition of an outbound inventory component 270 and an environment tracking component 280. Link 275 shows the services of the outbound inventory component 270 being provided to warehouse operations component 230, and link 285 shows environment tracking component 280 relying upon services provided by distribution scheduling component 240. Further, these additional components are enhanced using examples stored in the repository 220. A supply chain example 227 shows that improved coordination with the supply chain can reduce the storage time of goods in transit, thereby reducing warehouse capacity needs. An adaptation of this example 227 provides the core functionality for the outbound inventory component 270. Similarly, a tracking traffic example 228, showing that distribution can be improved to take account of external factors such as weather conditions or traffic delays, is adapted to provide core functionality for the environment tracking component 280.

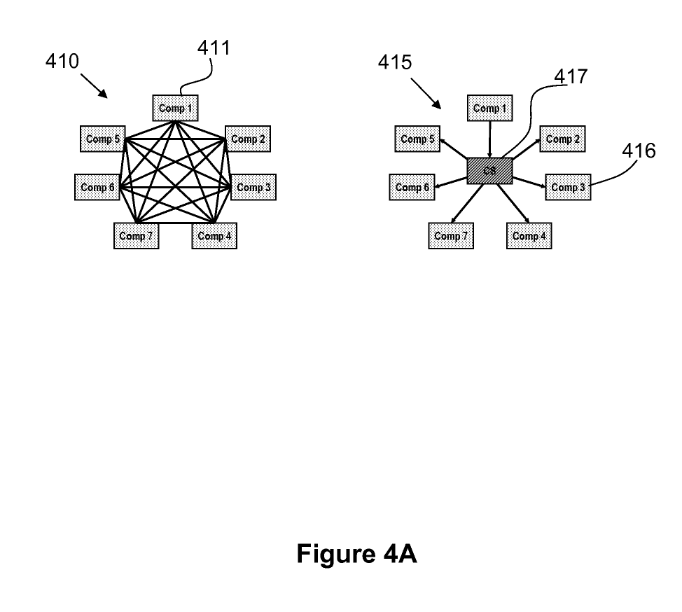

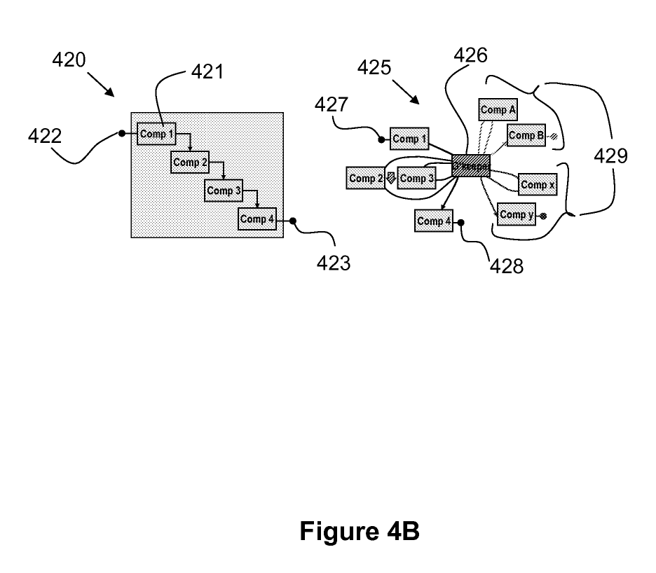

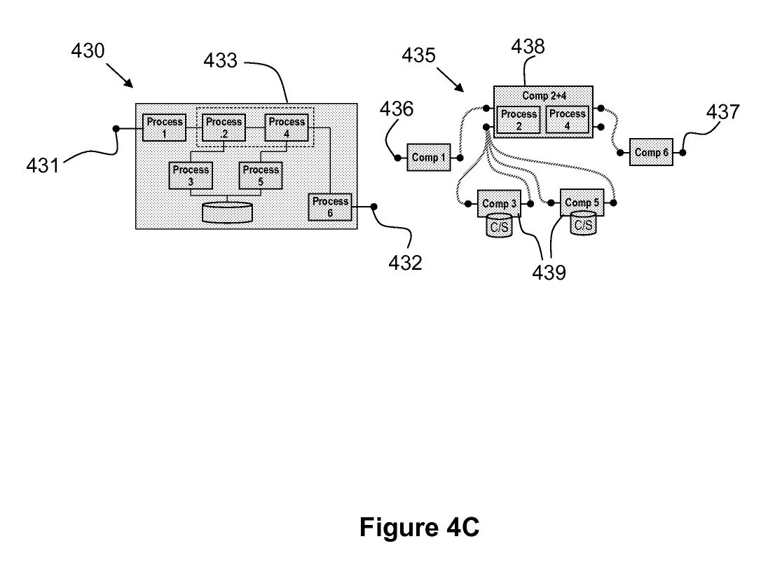

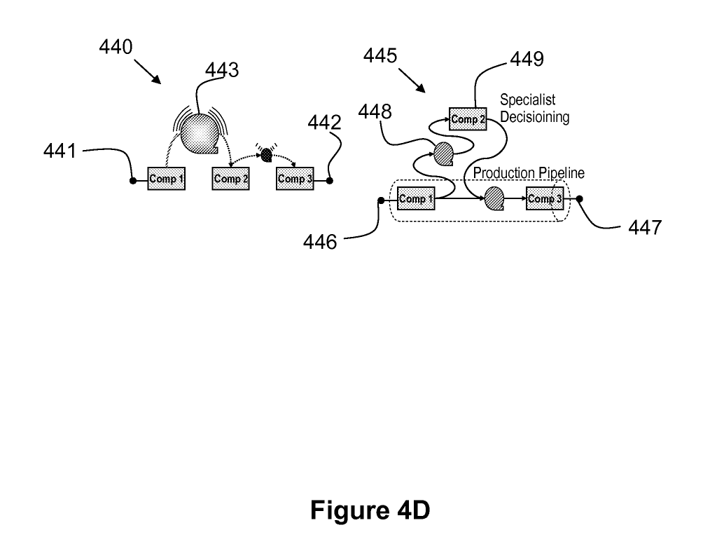

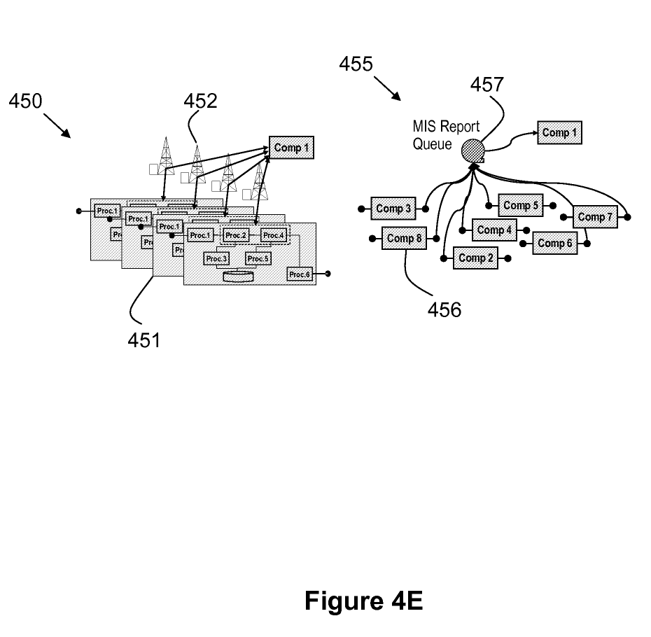

The collaborative networks described by the above referenced foundation patent application provide an analytical basis for improving alignment of the business to a Component Business Model by reconfiguring the collaboration. By reconfiguring the collaboration between components, the components themselves, and their respective competencies, will become better aligned to the Component Business Model. In particular, by reconfiguring business activities in the form of components and simplified collaborative patterns, the result will be components that are more independent and less overlapping, with better defined means of working with each other. These reconfigurations in accordance with the invention include the following five types of collaborative patterns for the roles of components in the execution of processes, which will now be explained with reference to FIGS. 4A through 4E. Three of these are easily equated with a process viewpoint, and two relate specifically to the collective view of processes across a collaborative service network.

FIG. 4A shows a reconfiguration of components who share information or services with the other components in the collaborative network, but independently as shown in diagram 410 where each component (e.g. 411) has direct links to the other components. In the revised configuration 415 a consolidator/server component 417 is added to the collaborative network, simplifying the connection between a component (e.g. 416) and any other component in the network. Consolidator/Server components provide a single access point for widely referenced information and/or services. The role of the component is to reduce the number of connections needed to reference and maintain information and so to improve the simplicity and consistency of business activity. When information is maintained independently in many locations there is increased potential for error and the need for significant connectivity to ensure changes are coordinated.

Before the reconfiguration, as shown in 410, similar information and services are developed where they are needed and peer connectivity is used to coordinate changes. After the reconfiguration, as shown in 415, all users reference a specialist component, using common services to reference and update the information. Components may maintain local copies of information for performance purposes with a number of possible protocols used to update or reference the specialist component (e.g. access when required, broadcast changes, periodic update of local copies).

Consolidator/server components 417 may be developed from a legacy application or more typically are supported by new purpose built systems. Referencing components can retain their local data structures to limit internal change, but local maintenance logic is removed and replaced by service access routines that reference the specialist component. These may include local encapsulation or wrappers for isolated conversion. The result of the reconfiguration is reduced complexity (multiple links between peer components are eliminated), improved responsiveness (changes in one area are captured centrally and relayed to other subscribing components), improved quality (errors are reduced because central governance eliminates double updates and inconsistency), and enhanced capabilities (single specialist service component supports focused incremental development of enhancements).

While the value of such components is often understood in connection with computer systems for handling information, the present invention recognizes a more generic application of this principle to collaborations among components. Collaboration places concrete burdens upon a component for the allocation of staff and other resources and the development of suitable controls for the management of the collaboration activity as an operational behaviour. These resource allocations and controls for collaboration are made visible by the CBM view of the business and may be streamlined by use of a consolidator/server component.

The visibility of component collaborations in a CBM view may also support a reconfiguration of those collaborations to create a component having different characteristics than those described for the consolidator/server of FIG. 4A. FIG. 4B shows a transition from a pre-defined collaborative process 420 to a more flexible collaboration 425 able to respond to situations not contemplated by the predefined process. In the pre-defined process 420, there is a trigger or input 422 followed by execution of the process by the various components (e.g. 421) in the pre-defined collaboration, with a result or output 423 at the end of the process. In the revised configuration 425 a gatekeeper component 426 is added, making available intermediate results or outputs that can be used by other component collaborations 429, in addition to result or output 428 in response to trigger or input 427. Gatekeeper components, such as 426, oversee access to other components for complex business transactions where different situations may require different responses. The gatekeeper component 426 seeks to ensure that all necessary tasks and all possible opportunities to leverage an event are exercised in an optimised combination or sequence.

Before the reconfiguration business events are processed following a pre-defined approach, and optional tasks are not always identified and exploited. After the reconfiguration business events are ‘gang tackled’ leveraging all facilities and exercising all applicable tasks viewed across the enterprise. Gatekeeper components are triggered by an event, such as a customer contact, following a decision making logic that invokes as many responsive activities in parallel as possible and in an optimal sequence. In addition the gatekeeper component will determine whether the triggering event presents an opportunity to initiate other responses (such as cross-sell) or process pending tasks (such as deliver mail).

Gatekeeper components implemented in computer systems will more typically be purpose built but may consolidate decision making logic from legacy computer systems. Their development needs to be incremental as new services are enabled with the development of processor and consolidator/server components. Decision making logic may be migrated from legacy applications as they are re-purposed. One advantage of migrating to gatekeeper components is that each business event is fully leveraged to invoke all applicable components and pending processes. Another advantage is improved responsiveness, since business rules can be streamlined and optimised to provide optimal response. Further, additional flexibility is provided because tasks which are not inherently in a particular sequence are decoupled, allowing execution in parallel and allowing these tasks to be sequenced in an event driven or state driven manner.

Those skilled in the art will appreciate that the foregoing description directed toward implementation of the invention in computer implemented processes may readily be extended to generic business processes. Component collaborations made visible by the CBM view of a business process enable use of gatekeeper components to fully expose and leverage for the business as a whole operational behaviours embedded within a business process.

FIG. 4C shows a transition from a monolithic configuration 430 of process steps to a revised configuration 435 which separates process steps and links them in a collaborative network. In this transition a monolithic business process 433 with trigger or input 431 and result or output 432 is broken down into a streamlined processor component 438 linked to other components (e.g. 439) providing necessary services. The streamlined processor component 438 continues to produce the desired output or result 437 in response to input or trigger 436. Processor components (such as 438) encapsulate specialised operational capabilities covering particular steps in a business process. They are reduced from the full monolithic business process 433 to include only the specific functionality needed to fulfil the role defined by its specialized operational capabilities, with all other required services provided through collaborations with other components. It is also necessary that the processor component 438 present a service interface so that the particular business process steps encapsulated are accessible from other components as appropriate.

Before the reconfiguration the business process is encapsulated in a monolithic style, containing within itself all associated services and imposing a rigid workflow. After the reconfiguration, processing is streamlined, tasks are generalised and de-coupled, and specialized generic services are leveraged. Processor components configured as described above reduce processing of the component to a streamlined minimum, referencing consolidator/server components for common information and services and linking with other processor components, optionally through the oversight of gatekeeper components to execute a business transaction. By decomposing a business process into generalised tasks where possible, re-use is maximised. In practical terms, this provides ‘service-enabled’ implementation of the business process, thereby maximizing flexibility since constituent components can be ‘wired’ together in any working sequence or combination.

As applied to computer implemented business processes, processor components will frequently be re-purposed legacy applications. Re-purposing will be a combination of breaking the legacy application into component aligned modules, wrapping these modules in a supply or subscription service interface and extracting and remotely referencing any functionality that is better supported by a consolidator/server component. The advantages of this technique are reduced complexity and improved performance (a processing component is reduced to an optimised processing minimum), improved re-use (a streamlined component provides a generalized service), and improved flexibility (i.e. a streamlined processor component is enabled as a service).

While the benefits of this form of transformation are often understood with respect to computer implemented systems, the present invention provides a basis for a more generic appreciation of reconfiguring collaborations based upon a CBM view of the business. This is particularly evident in item 430 of FIG. 4C, which is a typical process oriented view containing no suggestion of a component. By overlaying processes upon a CBM view, the relevant components and their collaborations become visible. In general, these collaborations are implemented not by computer systems but by staff and other resources, sometimes with only ancillary support from technology of various kinds. Similarly, management control objectives that constrain the business process may or may not be implemented or supported by automated technology. Regardless of the particulars of the operational behaviours that make up a business process, the locus and distinctiveness of the component representation of these operational behaviours and the collaborations between them become visible in a CBM view. Based on that visibility, the present invention is able to reconfigure the collaborations to make particular operational capabilities more flexibly available to the business as a whole.

FIG. 4D shows a transition from a configuration 440, where an execution step requiring special attention is imbedded in a sequence, to a revised configuration 445, where the special attention step is extracted from the sequence pipeline for performance by a controller component. Prior to the transition the process sequence includes a step 443 between input 441 and output 442 that cannot be routinely resolved. Transition to collaborative pattern 445 involves extracting special attention step 448 and creating a controller component 449, removing uncertainty and delay from the production pipeline between input 446 and output 447.

Controller components oversee the execution of business. They perform checks, classification or qualification activity, handle exceptions and detect and resolve issues arising in execution. Controller components will typically support the oversight functions of line managers and will leverage information and technology to support operational decision making. Before a configuration change creating a controller component, checks and exceptions requiring specialist or senior staff involvement are tightly bound into execution, or are poorly supported, causing uncertainty and delay. After a suitable controller component is added, checks and exceptions are isolated from execution and routed to a specialist or senior decision making resources for resolution using suitable facilities.

Controller components both monitor execution activities and can be triggered by business events and exceptions. Checks may be required at certain times, due to certain situations or when thresholds are breached. Most typically a controller component will execute independently (asynchronously) of execution tasks, taking pending actions off and returning results to work queues. Where they support complex decisions they may invoke other controller components in the resolution of an issue. Controller components will more typically be purpose built but may consolidate decision making logic from legacy systems. Their development needs to be incremental as new services are enabled with the development of processor and consolidator/server components. Decisioning logic may be migrated from legacy applications as they are re-purposed. Controller components provide a point of focus for future incremental development, supporting ever more sophisticated decision making capabilities.

Controller components provide improved productivity by decoupling checks and controls from execution, thereby streamlining production. They also improve the leverage available from specialist resources by directing issues to facilities and individuals best qualified to address them. Further, controller components provide improved flexibility, since incremental development and collaborations between Controller components are highly flexible and scalable.

FIG. 4E shows a transition from a configuration 450 where production information (e.g. 451) is mined 452 in order to support management decision making, to a configuration supported by analyzer components (e.g. 456) providing standard management information system (MIS) extracts to an MIS report queue 457 available to decision makers. Analyzer components support decision making at the management level served by “direct components” (see discussion above regarding component maps) for determining how the business is to be run and evaluating performance. They present consolidated and historical business information, optionally supported by externally generated market information to support policy making and business direction. Analyser components can support scenario development, sensitivity analysis planning and consolidated business performance tracking.

Before the configuration 450 is changed, senior management decision making is constrained by the quality and timeliness of business information and the supporting analysis tools. Note that exemplar representation 451 of production information prior to reconfiguration is structured as a monolithic process similar to item 433 of FIG. 4C. After configuration 455 is implemented, key activity information is extracted and consolidated from control and execution components in standard formats with full analysis facilities. Analyzer components absorb summary business activity details over time. Standard message formats, schedules for extracting the desired information, and mechanisms for automating and standardizing the extract process ensure consistent information is used to direct the overall activity of the business. Some return reporting to the business from the Analyser components can be supported to communicate policies, budgets, goals priorities etc., though the benefits of automating such flows are less significant.

Analyzer components will more typically be purpose built but may consolidate existing reporting and analysis logic from legacy systems. Their development needs to be incremental as new activity information becomes available with the development of controller, processor gatekeeper and consolidator/server components. Improved business decisions flow from this configuration change, since improved quality and timeliness of business activity information supports better decisions. Also, analyzer components provide improved responsiveness because tighter feedback loops support more interactive policy development and business direction.

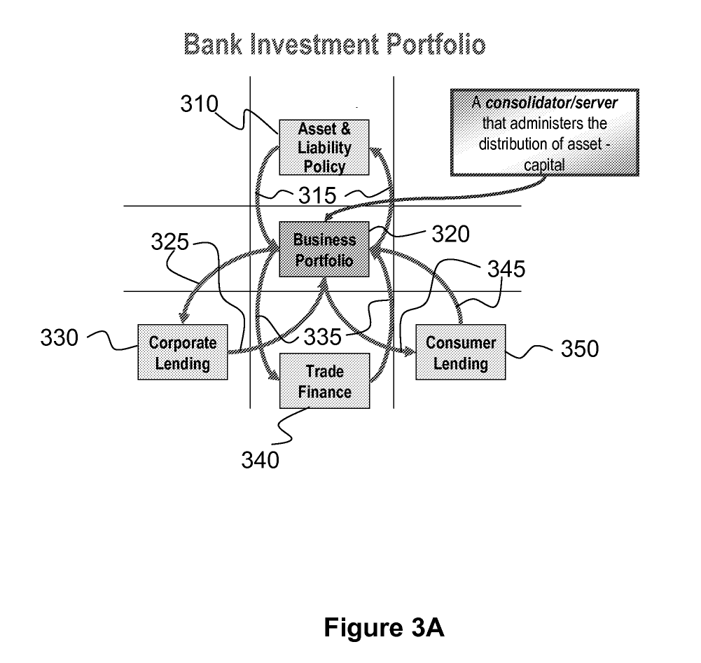

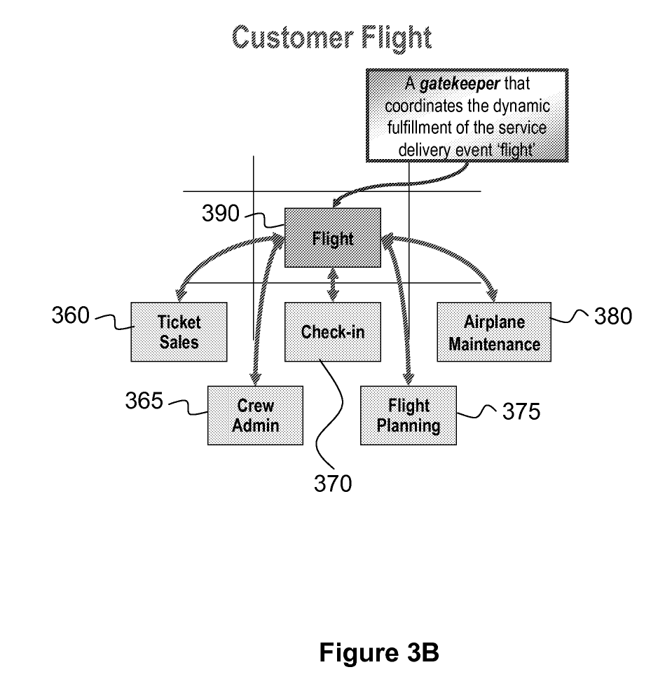

Turning now to FIGS. 3A and 3B, application of the invention to particular collaborative roles will be explained. Component network transformations in accordance with the invention flow from three main uses of the analytical tools provided by CBM. One use of a CBM description of a business is in identifying key information/assets. When these are managed across different processes by a consolidator/server component they can be better leveraged (as in allocating staff to projects, apportioning capital across initiatives, etc.).

FIG. 3A shows a simple example of use of a CBM description to develop a consolidator/server component. Component 310 handles asset and liability policy for a bank investment portfolio and collaborates with each of a number of bank investment components, including corporate lending component 330, trade finance component 340, and consumer lending component 350. Before reconfiguration these collaborations complicated the primary policy role of component 310. By providing a business portfolio component 320 to administer the distribution of asset capital in accordance with policy, these collaboration functions are consolidated in one component 320 that serves both asset and liability policy component 310 (via collaborations 315) and the bank investment components (via collaborations 325, 335 and 345).

Before the role of the consolidator/server component is identified using the CBM design approach, key business insights/perspectives can be dispersed across the many processes that may reference and change the associated information, often maintaining their own local versions of that information. In order to assemble and maintain a consolidated perspective in this situation complex coordination is required between all interested parties. The consolidator/server role defines a single entity responsible for maintaining a single perspective on behalf of all interested parties, managing access to avoid business decision and change conflicts and often enabling the more effective management and exploitation of the associated business resource or insight referenced by the information it maintains.

A second use of a CBM description is identifying key business events that can be trigger points for multiple activities. By describing a business in terms of components, components that have been imbedded in a linear business process can be optimally exploited by a gatekeeper component that enables parallel invocation of the formerly imbedded components.

FIG. 3B shows an example of use of a CBM description to develop a gatekeeper component 390 that serves to remove process linkages between and among the components for ticket sales 360, crew administration 365, check-in 370, flight planning 375 and airplane maintenance 380. Before reconfiguration the necessary coordination between these components was imbedded in inter-component process linkages, making change dependent upon further coordination between the affected components. After reconfiguration coordination is handled by the flight component 390, which can more readily respond to needs for changes in how the other components coordinate their activities.

Before the role of the gatekeeper is identified using the CBM design approach, many business activities may be supported by their own isolated procedures, executing independently and unaware of any interdependencies that might exist between them in the broader context of the overall business operation. The Gatekeeper role supports a business capability that can be impacted by events associated with one or more of many discrete activities on which it has some collective dependency. The gatekeeper detects and responds to an event associated with one business activity and determines and initiates a timely and appropriate response in other activities as may be required. The gatekeeper role allows the detection and proactive response to business events that would otherwise be dealt with in a reactive and uncoordinated manner as their implications are arbitrarily discovered across many otherwise disconnected activities.

A third use of a CBM description is for evolving an existing component that portrays a processor role in the existing operation to becoming a gatekeeper or consolidator/server type role. The above described example of just-in-time distribution is such an example when the distribution component evolves from being an end of day batch process (taking end of day sales reports, working out the delivery requirements, scheduling the loading and distribution, etc.) to a gatekeeper, where the distribution component gathers all this information in real-time and handles the triggering of multiple streams of activity, such as ordering goods, directing transport, and determining delivery requirements. These activities are related, but their fulfillment can be asynchronous to some degree and the role of the gatekeeper is to juggle these activities for the optimal performance.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A method for transforming a business, comprising:
using a Component Business Model (CBM) to generate a display linking a specified capability to component features contributing to the capability; and
enhancing performance of the specified capability by transforming the contributing components.

2. A method as in claim 1, wherein using a Component Business Model further comprises:
using a CBM map to identify collaborating components for the specified capability, the CBM map being a display generated from a CBM repository;
filtering a view of the identified components from the CBM repository, the view including linkages between services relied upon and services provided by the identified components; and
identifying from said filtered view features of each component contributing to the specified capability.

3. A method as in claim 2, wherein enhancing performance of the specified capability further comprises:
searching the CBM repository for exemplar applications of the contributing features; and
adapting the exemplar applications for use by the respective identified components having the respective contributing features.

4. A method as in claim 2, wherein enhancing performance of the specified capability further comprises:
identifying a collaborative pattern for the collaborating components; and
adding a component to perform the identified collaborative pattern.

5. A method as in claim 2, further comprising identifying additional features for the specified capability, and adding to said view at least one component providing the added features.

6. A method as in claim 4, wherein the collaborative pattern is a predefined process and the added component is a gatekeeper component.

7. A method as in claim 4, wherein the collaborative pattern is independent interconnection and the added component is a consolidator/server component.

8. A method as in claim 3, wherein a single component is identified and the contributing features are features of the single component.

9. A method as in claim 3, further comprising outsourcing at least one of the identified and adapted components.

10. A method as in claim 3, wherein at least one of the identified components is being provided by an entity external to the business, and further comprising integrating the external component into the business.

11. A system for transforming a business, comprising:
a Component Business Model (CBM) map for identifying components that collaborate toward a specified capability, the CBM map being generated as a display from a CBM repository;
a filter for generating a view of the identified components from the CBM repository, the view including linkages between services relied upon and services provided by the identified components;
means for identifying from said view features of each component contributing to the specified capability; and
means for enhancing performance of the specified capability by transforming the contributing components.

12. The system of claim 11, wherein said enhancing means further comprises:
means for searching the CBM repository for exemplar applications of the contributing features; and
means for adapting the exemplar applications for use by the respective identified components having the respective contributing features.

13. The system of claim 11, wherein said enhancing means further comprises:
means for identifying a collaborative pattern for the collaborating components; and
means for adding a component to perform the identified collaborative pattern.

14. The system of claim 13, wherein the collaborative pattern is a predefined process and the added component is a gatekeeper component.

15. The system of claim 13, wherein the collaborative pattern is independent interconnection and the added component is a consolidator/server component.

16. Implementing a service for transforming a business, comprising the method of:
using a Component Business Model (CBM) to generate a display linking a specified capability to component features contributing to the capability; and
enhancing performance of the specified capability by transforming the contributing components.

17. A method implementing a service as in claim 16, wherein using a Component Business Model further comprises:
using a CBM map to identify collaborating components for the specified capability, the CBM map being a display generated from a CBM repository;
filtering a view of the identified components from the CBM repository, the view including linkages between services relied upon and services provided by the identified components; and
identifying from said filtered view features of each component contributing to the specified capability.

18. A method implementing a service as in claim 17, wherein enhancing performance of the specified capability further comprises:
searching the CBM repository for exemplar applications of the contributing features; and
adapting the exemplar applications for use by the respective identified components having the respective contributing features.

19. A method implementing a service as in claim 17, wherein enhancing performance of the specified capability further comprises:
identifying a collaborative pattern for the collaborating components; and
adding a component to perform the identified collaborative pattern.

20. A computer implemented system for transforming a business, comprising:
first computer code for using a Component Business Model (CBM) map to identify components that collaborate toward a specified capability, the CBM map being generated as a display from a CBM repository;
second computer code serving as a filter for generating a view of the identified components from the CBM repository, the view including linkages between services relied upon and services provided by the identified components;
third computer code for identifying from said view features of each component contributing to the specified capability; and
fourth computer code for enhancing performance of the specified capability by transforming the contributing components.
